(19) United States
(12) Patent Application Publication
(10) Pub. No.: US 2012/0194348 A1
(43) Pub. Date: Aug. 2, 2012

(54) HOUSEHOLD APPLIANCE, IN PARTICULAR A HOUSEHOLD DISHWASHING MACHINE

(75) Inventors: Reinhard Hering, Holzheim (DE); Michael Georg Rosenbauer, Reimlingen (DE)

(73) Assignee: BSH Bosch und Siemens Hausgerate GmbH, Munich (DE)

(21) Appl. No.: 13/498,151

(22) PCT Filed: Sep. 24, 2010
(86) PCT No.: PCT/EP2010/064092

§ 371 Date: Mar. 26, 2012

(30) Foreign Application Priority Data
Oct. 12, 2009 (DE) 10 2009 045 594.9

(51) Int. Cl. G08B 21/00; A47L 15/42; A47B 81/00

(52) U.S. Cl. 340/679; 312/237; 312/228

(57) ABSTRACT

A household appliance includes a treatment compartment, an appliance door for opening the treatment compartment to allow loading thereof and closing the treatment compartment to allow unloading thereof, and an operating display unit having at least one visual and/or acoustic display configured at least to display and/or signal a completed treatment cycle of items to be treated in the treatment compartment. A detector detects a position of the appliance door and is configured to deactivate at least the display when detecting at least one selected predefinable door position of the appliance door.

The invention relates to a household appliance, in particular a household dishwasher, at least having a treatment compartment, which can be opened for loading and/or unloading and closed by means of an appliance door of the household appliance, also at least having an operating display with at least one visual and/or acoustic display means, which is configured at least to display and/or signal a completed treatment cycle of items to be treated in the treatment compartment.

When consumer organizations rate household appliances, the energy consumption of the household appliance, in particular also its annual energy balance sheet, plays a significant role. Household appliances have an operating display with at least visual display means, for example LEDs, which can be used during the operation of the household appliance to display operating parameters, etc. and after completion of a treatment cycle according to a program to indicate that the treatment cycle has been completed. However after the end of the program the household appliance remains connected to the power supply network until the customer actively intervenes and deactivates the household appliance by actuating the main switch.

The object of the invention is to provide a household appliance, in particular a household dishwasher, with which energy consumption is further reduced.

According to the invention appliance door position detection means are provided, with at least the display means being deactivated on detection of at least one selected appliance door position by the appliance door position detection means. The invention is based on the knowledge that, from the current door position of the appliance door after completion of a treatment cycle or at the end of a program, conclusions can be drawn as to whether or not operation of the visual display means continues to be necessary for the user. If a door position is detected, in which it is not deemed necessary for example to display the end of the program, the program end display means can be deactivated.

For example after completion of a treatment cycle when a closed appliance door is detected at the same time, a program end display may be significant for the customer so that said customer is informed about the current operating state of the household appliance. In contrast after completion of a treatment cycle when the appliance door is already half open or slightly open, the conclusion can be drawn that the user has already been informed that the program has ended and by opening the appliance door to a slightly open position or a half open position wishes first to cool the treatment chamber or the treated items therein. It is thus usual, with household dishwashers in particular, at the end of the program to pivot the appliance door from the closed position to a slightly open door position or to a half open door position to speed up the cooling of the washed items. When the appliance door is in such a slightly open or opened position at the end of the program, a program end display is of no benefit to the customer so the display means can be deactivated.

In one preferred embodiment provision is made for the appliance door position detection means to be connected for signal transmission purposes to a control device of the household appliance to deactivate the display means and for the control device to deactivate the display means in response to a signal from the appliance door detection means representing the selected door position. This has the advantage that the appliance door detection means can also be used as trigger means for other functions that are triggered using the control device of the household appliance, such as the activation of an interior light of the treatment compartment for example.

In a further, preferred embodiment provision is made for the appliance door position detection means to be configured to interrupt an energy supply supplying the display means with energy when the selected door position is reached. On detection of the selected door position the appliance door position detection means interrupts an energy supply supplying the display means with electrical energy to deactivate the display means. This allows a particularly simple structure to be achieved, in which the appliance door detection means acts as a switch, which interrupts a power line supplying the display means with electrical energy.

Generally the selected appliance door position, in which the program end display means are deactivated, can be between a completely open and a completely closed appliance door position. In the completely open appliance door position the program end display means can optionally also be reactivated.

In the case of a household dishwasher the abovementioned selected appliance door position can be for example a slightly open position or a half open position, in which the loading and/or unloading of the treatment compartment is prevented, this generally only being able to take place in the fully open appliance door position, in which in the case of a household dishwasher the appliance door is in the horizontal plane.

The visual display means can also be automatically deactivated, at least partially, after completion of a treatment cycle, optionally immediately after detection of the abovementioned selected appliance door position.

The appliance door position detection means can have at least one Hall sensor. The use of Hall sensors in door closing systems is generally known. The Hall sensor interacts with a permanent magnet in the manner of a position detection sensor or contactless button. The Hall sensor can therefore preferably be disposed for example in a fixed position on a housing of the household appliance and can interact with a magnet disposed in the generally pivotable appliance door.

Alternatively the Hall sensor can also be disposed on the appliance door. A Hall sensor thus disposed detects whether the appliance door is closed or open. Therefore if the Hall sensor detects an open position of the appliance door, a controller of the household appliance connected to said Hall sensor for signal transmission purposes can generate the deactivation signal, in response to which the display means can be deactivated.

As an alternative to a Hall sensor at least one tilt switch can be used as the door position detection means, detecting for example a pivoting movement from a for example vertically closed door position to an angled position of the appliance door. An angle measuring device can however also be used instead of the tilt switch.

Provision is also preferably made for the on switch and off switch to be connected in a parallel manner. The power supply network can be in contact for example with an on switch configured as a microswitch and the switching element connected parallel to this. When the household appliance is out of operation, both the on switch and the switching element are open. Actuation by pressing of the microswitch allows the deactivated, i.e. open, switching element of the self-holding contact circuit to be bridged, with the result that a voltage pulse is applied to the control device. The voltage pulse is directed by way of the control device to the self-holding contact circuit, with the result that the self-holding contact circuit closes the switching element. This allows current from the network to flow by way of the now closed switching element to the self-holding contact circuit so that the switching element remains closed in a stable manner, while the on switch is opened again. As soon as the control device directs the deactivation signal to the self-holding contact circuit, said circuit opens the switching element, causing the power supply into the household appliance to be interrupted.

Provision is preferably made here for an equally high electrical voltage to be present at the on switch and the off switch. This allows a particularly simple structure.

Provision is preferably made here for the on switch and the off switch to be connected to the control device in such a manner that an activation and/or deactivation pulse is transmitted. Provision is preferably also made for the power supply unit to be disposed in such a manner that it forms a series circuit with the on switch and the off switch. Provision is also preferably made for the control device to be connected to the power supply unit in such a manner that it can be supplied with electrical energy. Provision is furthermore preferably made for the operating display to be connected to the power supply unit in such a manner that it can be provided with electrical energy. Finally provision is preferably made for the self-holding contact circuit to be assigned to a controller that can be actuated by the control device.

The self-holding contact circuit can preferably have a bistable relay, to which a relay contact acting as a switching element can be connected. Such a bistable relay is primarily characterized by the attribute that in the power-free state it can adopt two different stable switching states. A relay contact of the bistable relay can also be connected as a switching element in the main supply line of the household appliance. When the deactivation signal is applied to the bistable relay, it switches the relay contact from a stable power-free open state to a stable power-free closed state or vice versa, with the result that the household appliance is decoupled completely from the network or connected to it. A flipflop, in particular an RS flipflop, can be used instead of a relay.

Finally provision is preferably made for the self-holding contact circuit to be connected to the off switch in such a manner that the off switch can be switched to an open state so that isolation from the supply voltage is possible in a simple manner.

In a method for operating the household appliance the current appliance door position is detected and analyzed by an analysis unit of the control device of the household appliance. The detected appliance door position is compared in the analysis unit. If the detected appliance door position corresponds to the selected appliance door position, the control device can deactivate at least the visual display means.

Advantageous developments are set out in the subclaims.

An exemplary embodiment of the invention is described in more detail below with reference to the accompanying figures, in which:

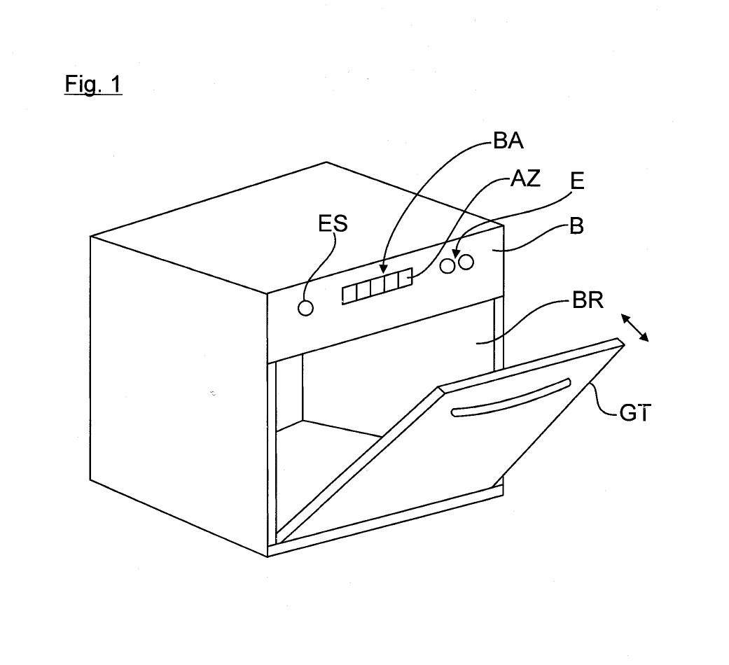

FIG. 1 shows a schematic perspective view of a household dishwasher;

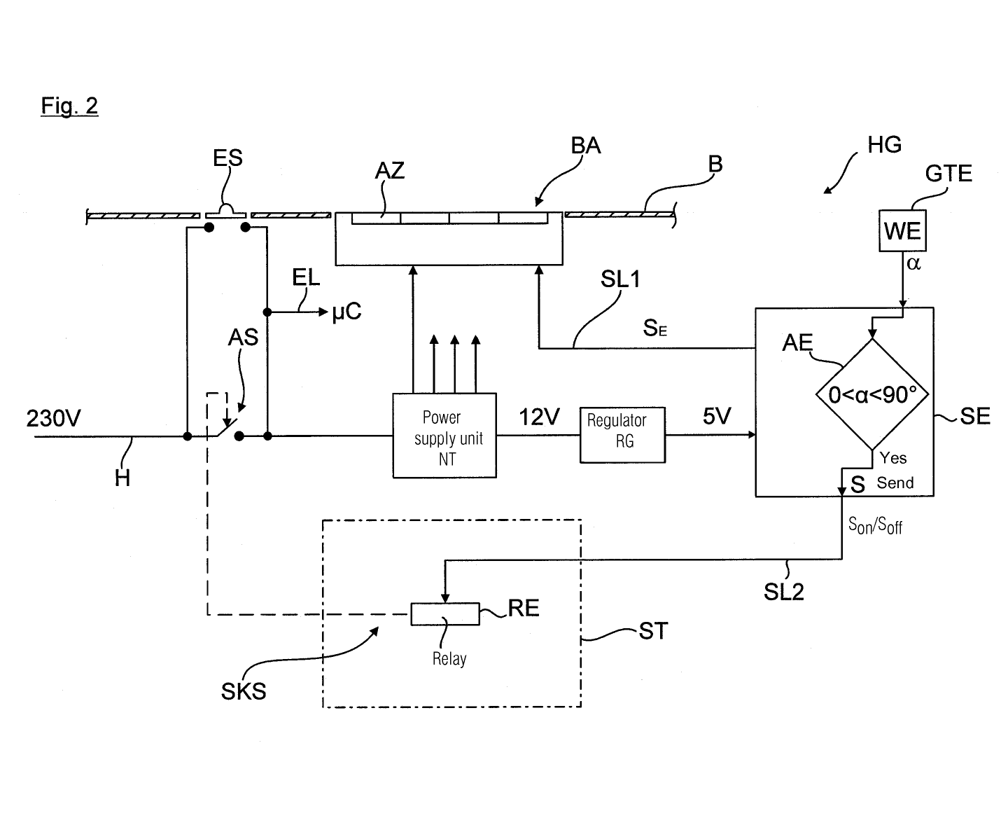

FIG. 2 shows a circuit arrangement of the household dishwasher; and

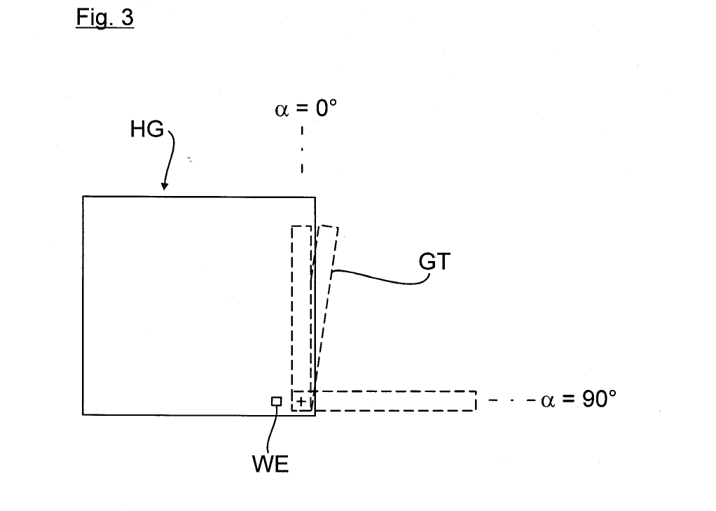

FIG. 3 shows a basic diagram of the household dishwasher with different appliance door angle positions.

FIG. 1 shows an exemplary embodiment of a household appliance in the form of a household dishwasher with a front appliance door GT, which can be pivoted in the known manner about a horizontal pivot axis at the bottom and with which a loading opening of the wash compartment BR can be opened for loading and/or unloading or closed. The loading opening is bounded at the top by a control panel B, which holds a microswitch ES and (simply indicated) visual display means AZ of an operating display BA. Input means E are also provided, which can be used to input operating parameters for a wash cycle of the household dishwasher.

The microswitch ES provided in the left region of the control panel B in FIG. 1 is configured here as a pushbutton switch for example. Actuation by pressing of the microswitch ES allows the household dishwasher to be switched to operation readiness, while subsequent actuation by pressing decouples the household dishwasher from the power supply network.

FIG. 2 shows a circuit arrangement, in which the microswitch ES and the operating display BA by way of example are integrated. In the circuit arrangement shown the household dishwasher is connected by way of a main supply line H to the power supply network. Connected in series in the main supply line H are a switching element AS (described below) and a power supply unit NT.

The power supply unit NT converts the network voltage of for example 230 V to a low voltage of 12 V. The low voltage 12V is converted by means of a regulator RG connected in series downstream of the power supply unit NT to a low voltage of 5 V, which is supplied to a control device SE. The power supply unit NT also supplies other appliance components and also the operating display BA of the household dishwasher with low voltage by way of additional outputs.

The control device SE is integrated in a control module (not shown in detail) and during the execution of a wash program actuates the visual display means AZ of the operating display BA and further appliance components, for example the drain pump or the circulating pump, by means of control signals S_{E} by way of a first signal line SL1.

In the circuit arrangement in FIG. 2 the control device SE is connected to an angle measuring device WE, which can detect different tilt angles a of the appliance door GT, as shown in FIG. 3. According to this when the appliance door GT is closed and vertical, the detected tilt angle α=0. Depending on the opening state of the appliance door GT, the tilt angle a that can be detected by the angle measuring device WE can vary within an angle range from 0 to maximum around 90°.

At a tilt angle α of 90° the appliance door GT is in its completely open, roughly horizontal position, in which it is possible to load and unload the wash compartment BR. In contrast such loading and unloading of the household dishwasher is largely prevented when the tilt angle α of the appliance door GT is between the fully open and the fully closed appliance door GT.

To analyze the current tilt angle α, the control device SE according to FIG. 2 has an analysis unit AE, in which the detected tilt angle α is compared with the predefined angle positions 0 and 90° of the appliance door GT. Depending on the result of this comparison the analysis unit AE of the control device SE can generate a deactivation signal S_{off}, by means of which the off switch AS can be controlled into its open position, as described below.

As also shown in FIG. 2, the control device SE is connected by way of a second signal line SL2 to a bistable relay RE of a self-holding contact circuit SKS. The abovementioned switching element AS, which is connected in the main supply line H instead of a mechanical main switch and as such takes on a main switch function, which can be used to decouple the household dishwasher from the power supply network or connect it to it, is assigned to the bistable relay RE as a relay contact.

When the household dishwasher is out of operation both the microswitch ES and the switching element AS are open. The deactivated household dishwasher is brought into operation by actuation by pressing of the microswitch ES, causing the initially still open switching element AS to be bridged. The actuation by pressing of the microswitch ES causes a voltage pulse to be generated, which is directed by way of the power supply unit NT and by way of the regulator RG to the control device SE.

The control device SE then forwards an activation signal Sₒₙ to the bistable relay RE causing its relay coil to attract and the switching element AS to be switched from the power-free stable open state to a power-free stable closed state. This causes the microswitch ES, which after actuation by pressing is again open, to be bridged by the now closed switching element AS, with the result that the network voltage is present at the power supply unit NT.

The household dishwasher is therefore switched to operation readiness so that a wash program can then be started by means of the input means E. After the end of the wash program, the control device SE deactivates the appliance components, for example the drain pump or circulating pump.

Immediately after completion of the wash program the analysis unit AE of the control device SE starts a comparison of the currently detected tilt angle α with the preset angle positions 0 and 90°. If a tilt angle α of 0 is detected, the analysis unit AE detects that the appliance door GT is closed. If the detected tilt angle α is between 0 and 90°, or the tilt angle a corresponds to roughly 90°, the analysis unit AE detects that the appliance door GT is partially or completely open.

In the present example the analysis unit AE is set so that the program end display means AZ remain activated both when the appliance door GT is completely open and when it is completely closed, while in the intermediate positions of the appliance door GT the program end display means are to be deactivated.

To deactivate the visual display means AZ, when an intermediate position of the appliance door GT has been detected, the control device SE generates the abovementioned deactivation signal S_{off} by means of which the bistable relay RE is actuated by way of the second signal line SL2 immediately after completion of the wash program. The relay RE then switches the switching element AS from the closed position to the open position, with the result that the household dishwasher is isolated completely from the power supply network.

The switching element AS of the relay RE therefore operates as a main switch which automatically isolates the power supply unit NT of the household dishwasher from the power supply network after the end of the wash program. This means that after the end of the program a supply of power by way of the power supply unit NT to the visual display means AZ of the operating display BA in particular is also interrupted. Therefore an energy-consuming visual display only takes place until the user opens the appliance door GT.

As also shown in FIG. 2, the microswitch ES is connected directly to the control device SE for signal transmission purposes by way of an input line EL. The voltage pulse supplied when the microswitch ES is actuated manually by pressing is therefore also directed directly to the control device SE, which detects and analyzes the pulse.

On detection of such a voltage pulse the control device SE checks whether the power supply unit NT is already activated when the microswitch ES is activated by pressing. If the power supply unit NT is not yet activated, the control device SE identifies activation actuation by the user and uses the activation signal Sₒₙ, as described above, to actuate the relay RE. If the power supply unit NT is already activated, the control device SE identifies a deactivation actuation by the user from the actuation by pressing of the microswitch, so the control device SE directs a corresponding deactivation signal S_{off} to the relay RE. The household dishwasher is then taken out of operation. Any ongoing wash program is therefore interrupted.

### List of Reference Characters

ES On switch

AS Off switch

H Main supply line

B Control panel

AZ Display means

BA Operating display

EL Input line

RG Regulator

SE Control device

RE Bistable relay

SKS Self-holding contact circuit

ST Controller

HG Household appliance

SL1, SL2 Signal lines

AE Analysis unit

GT Appliance door

HS Hall sensor

GH Housing

GTE Appliance detection means

WE Angle measuring device

BR Treatment compartment

1-15. (canceled)

16. A household appliance, comprising:
a treatment compartment;
an appliance door for opening the treatment compartment to allow loading thereof and closing the treatment compartment to allow unloading thereof;
an operating display unit having at least one visual and/or acoustic display configured at least to display and/or signal a completed treatment cycle of items to be treated in the treatment compartment; and
a detector for detecting a position of the appliance door, said detector being configured to deactivate at least the display when detecting at least one selected predefinable door position of the appliance door.

17. The household appliance of claim 17, constructed in the form of a household dishwasher.

18. The household appliance of claim 16, further comprising a control device, said detector being connected for signal transmission to the control device to deactivate the display, wherein the control device is configured to deactivate the display in response to a signal from the detector representing the at least one selected door position.

19. The household appliance of claim 16, further comprising an energy supply supplying the display with energy, said detector being configured to interrupt the energy supply to the display when the at least one selected door position is reached.

20. The household appliance of claim 16, wherein in the at least one selected door position, the appliance door is in a position between a completely open position of the appliance door and a completely closed position of the appliance door.

21. The household appliance of claim 16, wherein in the at least one selected door position the appliance door prevents loading and/or unloading of the treatment compartment.

22. The household appliance of claim 16, wherein the visual and/or acoustic display is deactivatable after completion of a treatment cycle.

23. The household appliance of claim 16, wherein the detector comprises at least one Hall sensor.

24. The household appliance of claim 23, further comprising a housing defining the treatment compartment, said Hall sensor being disposed on the housing.

25. The household appliance of claim 23, wherein the Hall sensor is disposed on the appliance door.

26. The household appliance of claim 16, wherein the detector comprises at least one tilt switch.

27. The household appliance of claim 16, wherein the detector comprises at least one angle measuring device.

28. The household appliance of claim 16, wherein the household appliance is deactivated in response to a detection of at least the selected door position.

29. A method for operating a household appliance, comprising:
detecting a position of an appliance door of the household appliance for loading and/or unloading a treatment compartment of the household appliance;
comparing the detected position of the appliance door with at least one predefinable appliance door position; and
deactivating at least one visual and/or acoustic display of an operating display unit, which display is configured at least to display and/or signal a completed treatment cycle of items to be treated in the treatment compartment of the household appliance.

30. The method of claim 29 for operating a household dishwasher.

31. The method of claim 29, wherein the at least one predefined appliance door position of the appliance door is between a fully open appliance door position and a fully closed appliance door position.

32. The method of claim 29, wherein the at least one predefined appliance door position is a position in which loading and/or unloading of the treatment compartment is prevented.

33. The method of claim 29, wherein the display is deactivated after completion of a treatment cycle.
